(19) United States
(12) Patent Application Publication
(10) Pub. No.: US 2011/0094797 A1
(43) Pub. Date: Apr. 28, 2011

(54) ELECTRIC WIRE WITH TERMINAL CONNECTOR AND METHOD OF MANUFACTURING ELECTRIC WIRE WITH TERMINAL CONNECTOR

(75) Inventors: Takuji Otsuka, Yokkaichi-shi (JP); Hiroki Hirai, Yokkaichi-shi (JP); Junichi Ono, Yokkaichi-shi (JP); Tetsuji Tanaka, Yokkaichi-shi (JP); Hiroki Shimoda, Yokkaichi-shi (JP); Akira Ito, Yokkaichi-shi (JP); Hisashi Higuchi, Yokkaichi-shi (JP); Masahiro Hagi, Yokkaichi-shi (JP)

(73) Assignees: Autonetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 13/001,488

(22) PCT Filed: Nov. 18, 2009
(86) PCT No.: PCT/JP2009/069542

§ 371 Date: Dec. 27, 2010

(30) Foreign Application Priority Data
Nov. 19, 2008 (JP) 2008-295787
Sep. 9, 2009 (JP) 2009-208457
Nov. 16, 2009 (JP) 2009-261030

(51) Int. Cl. H01R 4/18; H01R 43/00

(52) U.S. Cl. 174/84 C; 29/857

(57) ABSTRACT

An electric wire with terminal connector including an electric wire having a core wire including a plurality of wires and a female terminal connector including a wire barrel that is crimped onto the core wire exposed from the electric wire, the following steps are executed. The steps include a step of removing wire insulation covering an outer peripheral surface of the core wire to expose the core wire, a step of holding the exposed core wire with jigs provided in a pair and applying ultrasonic vibration to the core wire via the jigs, and a step of crimping the wire barrel so as to surround a part of the core wire to which the ultrasonic vibration is applied.

### TECHNICAL FIELD

The present invention relates to an electric wire with terminal connector and a method of manufacturing the electric wire with terminal connector.

### BACKGROUND ART

Conventionally, an electric wire with terminal connector disclosed in Patent Document 1 is known as an example of such a kind. The electric wire with terminal connector comprises an electric wire that is a core wire 13 including a plurality of wires and a terminal connector that is crimped onto the core wire that is exposed from the electric wire. The terminal connector includes a crimping portion that is crimped onto the core wire so as to surround it. The crimping portion is crimped onto the core wire so as to surround it, and this electrically connects the electric wire and the terminal connector.
[Patent Document 1] Japanese Unexamined Patent Publication No. 9-7647

### DISCLOSURE OF THE INVENTION

According to the above structure, the contact between an outer peripheral surface of the core wire and an inner surface of the crimping portion electrically connects the core wire and the crimping portion. If a layer having a relatively high electric resistance such as an oxide layer is formed on a surface of each wire forming the core wire, the wires may not be electrically connected to each other sufficiently due to the layer formed on each wire. In such a case, only the wires that are located at a radial outer portion of the core wire and connected to the inner surface of the crimping portion contribute to the electric connection between the core wire and the crimping portion. Accordingly, the wires that are located at a radial inner portion of the core wire may not contribute to the electric connection between the core wire and the crimping portion. This may increase an electric resistance between the electric wire and the terminal connector.

The present invention has been completed in view of the circumstances described above. It is an object of the present invention to provide an electric wire with terminal connector that decreases an electric resistance between an electric wire and a terminal connector and also provide a method of manufacturing such an electric wire with terminal connector.

The present invention provides a method of manufacturing an electric wire with terminal connector including an electric wire and a terminal connector. The electric wire is comprised of a core wire including a plurality of wires and the terminal connector includes a crimping portion that is crimped onto the core wire exposed from the electric wire. The method comprises a step of removing wire insulation covering an outer peripheral surface of the core wire to expose the core wire, a step of holding the exposed core wire with jigs provided in a pair and applying ultrasonic vibration to the core wire via the jigs, and a step of crimping the crimping portion onto a part of the core wire to which ultrasonic vibration is applied, the crimping portion being crimped onto the part so as to surround the part.

The present invention provides an electric wire with terminal connector including an electric wire and a terminal connector. The electric wire is comprised of a core wire including a plurality of wires and the terminal connector is crimped onto the core wire exposed from the electric wire. The electric wire with terminal connector comprises a roughed portion formed on a surface of the wire of the core wire that is exposed from the electric wire, and the roughed portion is formed by application of ultrasonic vibration to the wire. The terminal connector includes a crimping portion that is crimped onto an outer surface of the core wire so as to surround the core wire, and the crimping portion is crimped onto the roughed portion.

According to the present invention, the wires of the core wire rub against each other by the application of ultrasonic vibration to the core wire. This makes the surfaces of the wires to rub against each other, and accordingly the surfaces of the wires are roughed and the roughed portion is formed thereon.

If the crimping portion is crimped onto the core wire of the wires having the roughed portion, the wires rub against each other by the application of force from the crimping portion. Then, the roughed portion formed on the surfaces of the wires rub against each other, and this makes the layer such as the oxide layer formed on the surfaces of the wires to be removed. Then, the surfaces of the wires emerge. The exposed emerging surfaces are contacted to each other and the wires are electrically connected to each other. Thus, the wires located at a radial inner portion of the core wire contribute to the electric connection between the electric wire and the terminal connector. This decreases an electric resistance between the electric wire and the terminal connector.

As described above, according to the present invention, an electric resistance between the electric wire and the terminal connector is decreased.

### BRIEF DESCRIPTION OF THE DRAWINGS

FIG. 1 is a side view illustrating an electric wire with terminal connector according to one embodiment of the present invention;

FIG. 2 is a perspective view illustrating a female terminal connector;

FIG. 3 is a perspective view illustrating an electric wire from which wire insulation is removed;

FIG. 4 is a perspective view illustrating wires that are welded by ultrasonic waves;

FIG. 5 is a perspective view illustrating a wire barrel and the core wire before the wire barrel is crimped onto the wire core;

FIG. 6 is a cross-sectional view of FIG. 1 taken along line VI-VI;

FIG. 7 is an electron microscope photograph illustrating wires in EXAMPLE 1;

FIG. 8 is an electron microscope photograph illustrating surfaces of the wires in EXAMPLE 1;

FIG. 9 is an electron microscope photograph illustrating wires in EXAMPLE 2;

FIG. 10 is an electron microscope photograph illustrating surfaces of the wires in EXAMPLE 2;

FIG. 11 is an electron microscope photograph illustrating wires in EXAMPLE 3;

FIG. 12 is an electron microscope photograph illustrating surfaces of the wires in EXAMPLE 3;

FIG. 13 is an electron microscope photograph illustrating wires in COMPARATIVE EXAMPLE 1;

FIG. 14 is an electron microscope photograph illustrating surfaces of the wires in COMPARATIVE EXAMPLE 1;

FIG. 15 is a graph illustrating electric resistance values between the wires;

FIG. 16 is a perspective view illustrating a wire barrel and a core wire before the wire barrel is crimped onto the wire core according to another embodiment;

FIG. 17 is a plan view illustrating a terminal connector including an intermediate splicing structure according to the another embodiment;

FIG. 18 is a cross-sectional view illustrating the core wire that is plastically deformed by jigs and to which ultrasonic vibration is applied according to an additional embodiment;

FIG. 19 is a cross-sectional view illustrating the core wire that is plastically deformed into an ellipsoidal shape and to which ultrasonic vibration is applied according to a further additional embodiment;

FIG. 20 is a cross-sectional view illustrating the core wire that is plastically deformed in a circular shape and to which ultrasonic vibration is applied according to a further additional embodiment;

FIG. 21 is a perspective view illustrating the core wire before being plastically deformed by a roller device according to a further additional embodiment;

FIG. 22 is a perspective view illustrating the core wire after being plastically deformed by the roller device according to the further additional embodiment;

FIG. 23 is a cross-sectional view illustrating the core wire that is plastically deformed by the roller device and before the application of ultrasonic vibration from the molds according to the further additional embodiment;

FIG. 24 is a cross-sectional view illustrating enlarged main portions in a process of crimping the wire barrel in the electric wires with terminal connectors according to EXAMPLES 4 to 6;

FIG. 25 is a cross-sectional view illustrating enlarged main portions in a process of crimping the wire barrel in the electric wires with terminal connectors according to EXAMPLES 7 to 9;

FIG. 26 is a graph illustrating a contact resistance and fixing strength in the electric wires with terminal connectors according to EXAMPLES 4 to 6;

FIG. 27 is a graph illustrating a contact resistance and fixing strength in the electric wires with terminal connectors according to EXAMPLES 7 to 9;

FIG. 28 is a side view illustrating a process of applying ultrasonic vibration to the core wire in the electric wire with terminal connector according to a second embodiment of the present invention;

FIG. 29 is a side view illustrating the core wire after the application of ultrasonic vibration thereto; and

FIG. 30 is a side view illustrating the core wire after the distal end thereof is cut.

### DESCRIPTION OF THE REFERENCE NUMERALS

10 Electric Wire with Terminal Connector
11 ELECTRIC WIRE
12 FEMALE TERMINAL CONNECTOR (TERMINAL CONNECTOR)
14 WIRE INSULATION
15 WIRE
16, 30, 31, 42, 43 JIG (METAL MOLD)
17 ROUGHED PORTION
19 WIRE BARREL (CRIMPING PORTION)
24 CRIMPED PORTION
50, 51 METAL MOLD
60 CUT SURFACE

### BEST MODES FOR CARRYING OUT THE INVENTION

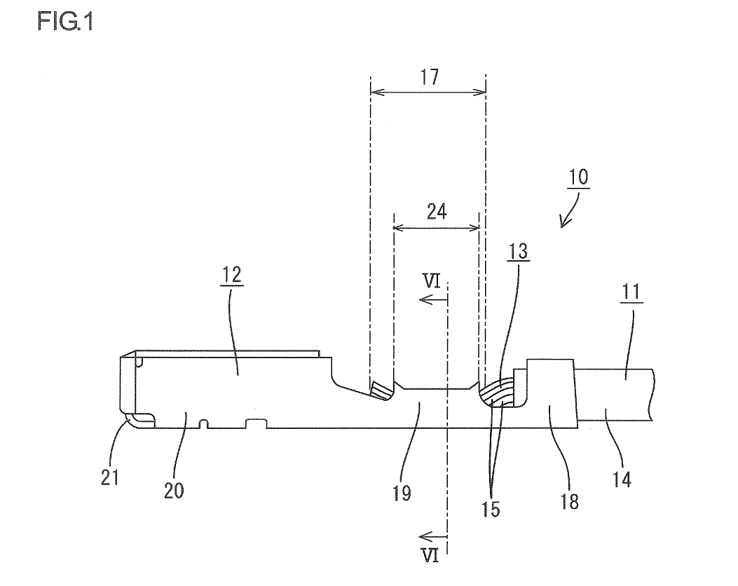

One embodiment of the present invention will be explained with reference to FIG. 1 through FIG. 15. An electric wire with terminal connector 10 according to the present embodiment includes an electric wire 11 and a female terminal connector 12 (corresponding to a terminal connector in claims) that is connected to an end of the electric wire 11. As illustrated in FIG. 1, the electric wire 11 extends in a horizontal direction in FIG. 1 with being connected to the female terminal connector 12.

(Electric Wire 11)

As illustrated in FIG. 1, the electric wire 11 comprises a core wire 13 and wire insulation 14 that surrounds an outer periphery of the core wire 13. Any metal suitable for intended application such as aluminum, aluminum alloy, copper, copper alloy or other metals can be used for the core wire 13. In the present embodiment, aluminum or aluminum alloy is used for the core wire 13. The core wire 13 is a stranded wire including a plurality of wires 15. The wire insulation 14 is removed at the end of the electric wire 11 for a predetermined length so as to expose the core wire 13.

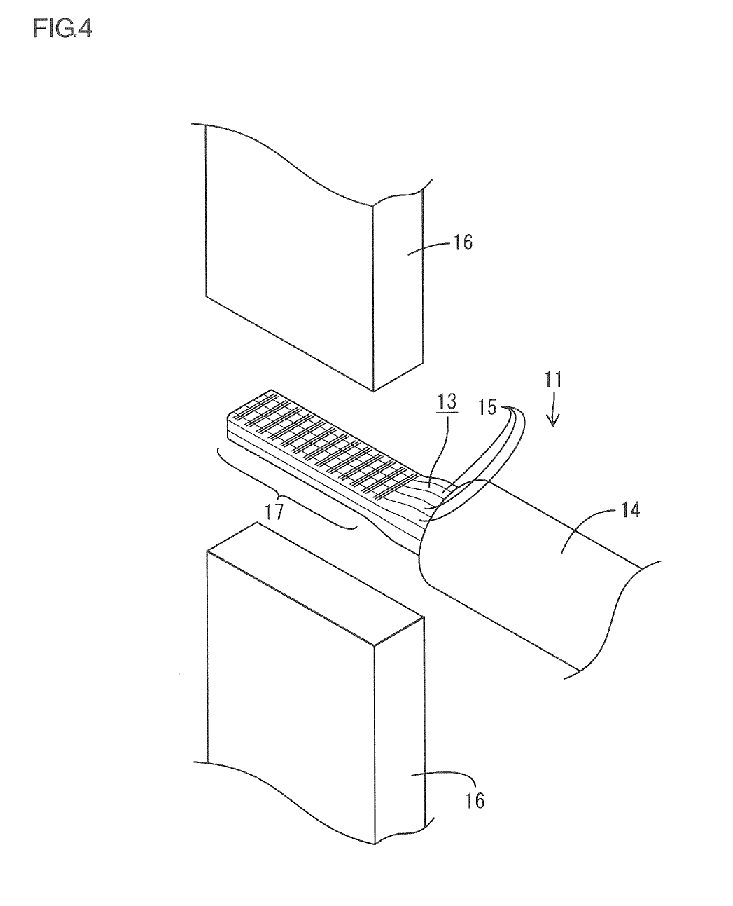

As illustrated in FIG. 4, in the present embodiment, the wires 15 of the core wire 13 exposed from the electric wire 11 are held between jigs 16, 16 provided in a pair and vibrated at ultrasonic frequency, and thereby the wires 15 are welded. Surfaces of the wires 15 rub against each other due to the ultrasonic vibration applied from the jigs 16, and thereby the surfaces of the wires 15 are roughed to form a roughed portion 17. The roughed portion 17 is formed on a surface of each of the wires 15 that are welded.

(Female Terminal Connector 12)

A metal plate material (not shown) is pressed into a predetermined shape with a die to form the female terminal connector 12. The female terminal connector 12 comprises insulation barrels 18 provided in a pair, a wire barrel 19 (corresponding to the crimping portion in claims) and a connecting portion 20. The insulation barrels 18 are crimped onto an outer periphery of the wire insulation 14 of the electric wire 11 so as to surround it. The wire barrel 19 is continuously formed from the insulation barrels 18 (on the left side of the insulation barrels 18 in FIG. 1) and crimped onto the core wire 13 so as to surround it.

The connecting portion 20 is continuously formed from the wire barrel 19 (on the left side of the wire barrel 19 in FIG. 1) and fitted to another terminal connector (not shown) to be electrically connected thereto. In the present embodiment, a male terminal connector is used as the another terminal connector. The connecting portion 20 is formed in a tubular shape so as to receive the male terminal connector. An elastic contact portion 21 is formed in the connecting portion 20. The elastic contact portion 21 is elastically contacted to the male terminal connector so as to electrically connect the male terminal connector and the female terminal connector 12.

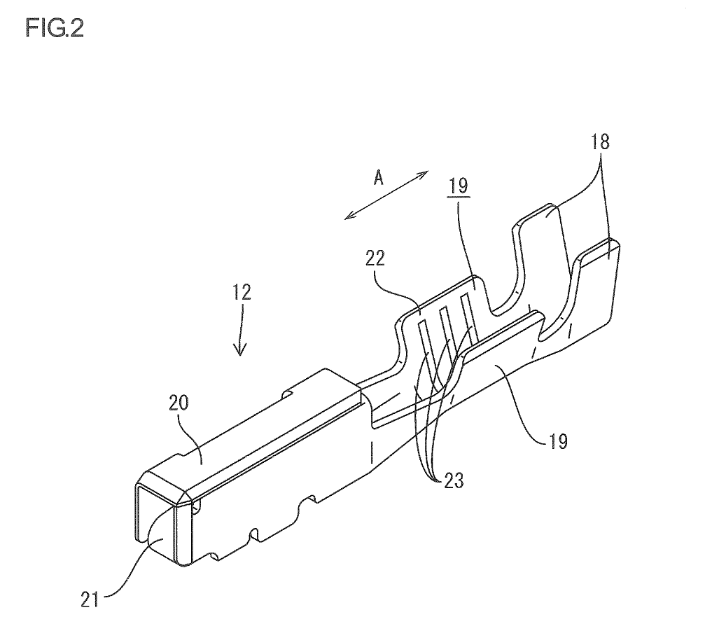

As illustrated in FIG. 2, recesses 23 are formed in a contact surface 22 of the wire barrel 19 that contacts the core wire 13. In the present embodiment, three recesses 23 are provided at regular intervals in an extending direction of the electric wire 11 (a direction illustrated by an arrow A in FIG. 2).

As illustrated in FIG. 1, the wire barrel 19 is crimped onto an outer periphery of the core wire 13 exposed from the electric wire 11 so as to surround it. The core wire 13 has a crimped portion 24 that is crimped by the wire barrel 19. In the present embodiment, the roughed portion 17 has a larger area than the crimped portion 24 in a horizontal direction in FIG. 1.

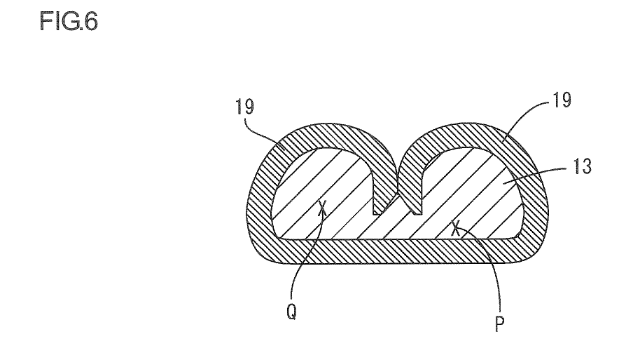

As illustrated in FIG. 6, the wire barrel 19 is crimped onto the core wire 13 so as to surround it such that the wire barrel 19 is pressed against the core wire 13. Then, the wire insulation of the oxide layer formed on the surface of the core wire 13 is removed and the surface of the core wire 13 emerges. The electric wire 11 and the female terminal connector 12 are electrically connected to each other by the contact of the emerging surface and the contact surface 22 of the wire barrel 19. In FIG. 6, the shape of the wire 15 is not illustrated.

One example of a method of manufacturing the electric wire with terminal connector 10 will be explained. First, a metal plate material is formed in a predetermined shape by press molding with a die (see FIG. 2). The recesses 23 may be also formed in this step.

Thereafter, the metal plate material that is formed in the predetermined shape is processed to be bent to form the connecting portion 20. The recesses 23 may be formed in this step.

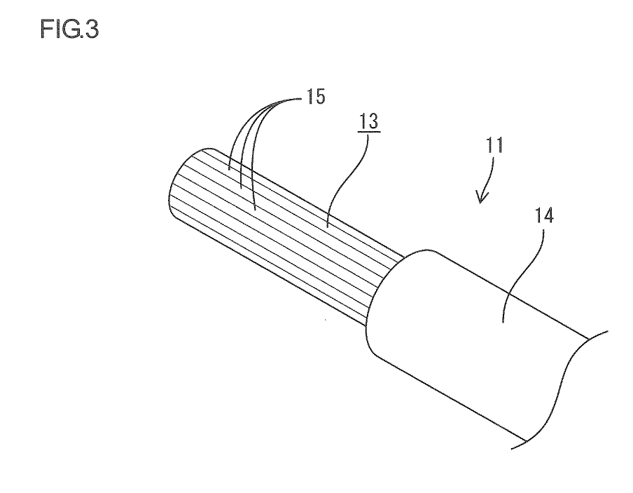

Then, the wire insulation 14 is removed at the end of the electric wire 11 to expose the core wire 13 therefrom (see FIG. 3). As illustrated in FIG. 4, the exposed core wire 13 is held between the jigs 16, 16 provided in a pair. In the present embodiment, the jigs 16, 16 hold the core wire 13 in a vertical direction in FIG. 4. After the core wire 13 is held between the jigs 16, the core wire 13 is vibrated at ultrasonic frequency with the jigs 16. Conditions of the ultrasonic vibration are already known.

By applying the ultrasonic vibration to the core wire 13, the wires 15 of the core wire 13 rub against each other. Accordingly, the surface of each wire 15 is roughed to form the roughed portion 17. If the ultrasonic vibration is further applied to the core wire 13, the surfaces of the wires 15 are melted by the frictional heat. Thereafter, the application of the ultrasonic vibration is stopped and the jigs 16, 16 are separated from each other such that the core wire 13 is removed from the jigs 16. Then, the removed core wire 13 is cooled down (releases heat), and thereby the wires 15 are welded. As illustrated in FIG. 4, the core wire 13 is formed to be flat with respect to a direction in which the jigs 16, 16 hold the core wire 13 therebetween (a vertical direction in FIG. 4).

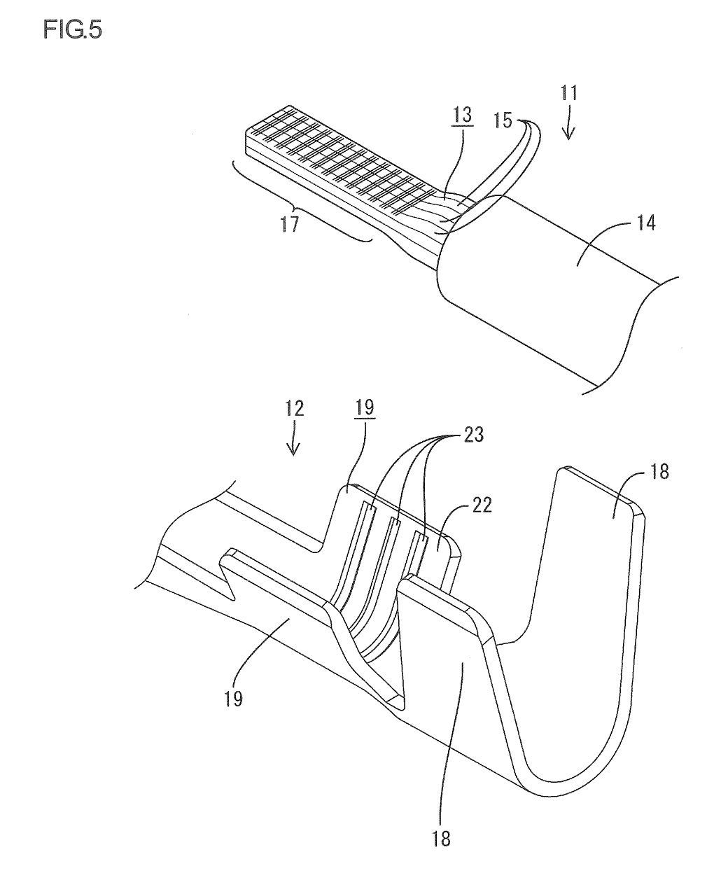

As illustrated in FIG. 5, after the application of ultrasonic vibration to the core wire 13, a portion of the core wire 13 including the roughed portion 17 is disposed on the wire barrel 19 and the wire insulation 14 is disposed on the insulation barrel 18, and in this condition, the electric wire 11 and the female terminal connector 12 are held by molds provided in a pair (not shown) in a vertical direction. Thereby, the barrels are crimped onto the electric wire 11. At this time, the electric wire 11 is disposed on the female terminal connector 12 such that the direction in which the jigs 16, 16 hold the core wire 13 (the vertical direction in FIG. 5) is consistent with the direction in which the molds hold the wire barrel 19 therebetween (in other words, each of the flat surfaces of the flat core wire 13 faces up and down respectively). The electric wire with terminal connector 10 is manufactured by the execution of the above process.

Operations and advantages of the present embodiment will be explained. According to the present embodiment, by the application of the ultrasonic vibration to the core wire 13, the wires 15 of the core wire 13 rub against each other. Rubbing of the surfaces of the wires 15 roughs the surfaces and forms the roughed portion 17 on the wires 15.

If the wire barrel 19 is crimped onto the core wire 13 of the wires 15 having the roughed portion 17, the wires 15 rub against each other by the application of force from the wire barrel 19. Thus, the roughed portion 17 formed on the surface of the wires 15 rub against each other, and this makes the layer such as the oxide layer formed on the wires 15 to be removed. Then, the surfaces of the wires 15 emerge. The exposed emerging surfaces are contacted to each other and the wires are electrically connected to each other. Thus, the wires 15 located at a radial inner portion of the core wire 13 contribute to the electric connection between the electric wire 11 and the female terminal connector 12. This decreases an electric resistance between the electric wire 11 and the female terminal connector 12.

Further, mutual adhesion of the contacted emerging surfaces suppresses that wire insulation such as the oxide layer is newly formed again on the emerging surface of the wire 15. Accordingly, the electric resistance between the electric wire 11 and the female terminal connector 12 is maintained to be low.

The wires 15 are welded to be electrically connected to each other. Therefore, when the core wire 13 is crimped, the wires 15 located at the radial inner portion of the core wire 13 surely contribute to the electrical connection between the electric wire 11 and the female terminal connector 12. This further decreases an electric resistance between the electric wire 11 and the female terminal connector 12.

In the present embodiment, the roughed portion 17 has a larger area than the crimped portion 24 of the core wire 13. Accordingly, since the wires 15 located in the crimped portion 24 surely has the roughed portion 17, the wires 15 that are located in the crimped portion 24 are electrically connected to each other by crimping of the crimping portion. As a result, the wires 15 and the terminal connector are electrically connected to each other more surely. This further decreases the electric resistance between the electric wire 11 and the female terminal connector 12.

In the present embodiment, the core wire 13 is formed of aluminum alloy. If the core wire 13 is formed of aluminum alloy, the wire insulation such as the oxide layer is relatively easy to be formed on the surface of the core wire 13. The present embodiment is effective in the case in that the wire insulation is easy to be formed on the surface of the core wire 13.

(Evaluation of Resistance Between Wires)

Model experiments are executed for examining influences of the ultrasonic vibration on the resistance between the wires. According to the model experiments, application of the ultrasonic vibration to the core wire 13 including the wires 15 decreases the electric resistance between the wires 15.

### Example 1

A metal plate material is pressed into a predetermined shape with a die. Then, the metal plate material that is formed in the predetermined shape is processed to be bent to form the connecting portion 20.

Thereafter, the wire insulation 14 is removed at the end of the electric wire 11 to expose the core wire 13 therefrom. Then, the core wire 13 is held between the jigs 16, 16 and the ultrasonic vibration is applied to the core wire 13 such that the wires 15 are welded. The condition at this time is that contact pressure of the jigs 16 is 13 bar, frequency is 20 kHz and applied energy is 80 Ws.

After the welded wires 15 are separated into a plurality of independent wires 15 again, the wire barrel 19 is crimped onto the core wire 13 and thus an electric wire with terminal connector 10 is manufactured.

As illustrated in FIG. 6, the wire 15 located close to a position P that is close to the radial outward portion of the core wire 13 and the wire 15 located close to a position Q that is close to the radial inward position of the core wire 13 are pulled out from the core wire 13 of the electric wire with terminal connector 10 thus manufactured to measure the electric resistance between the wires 15.

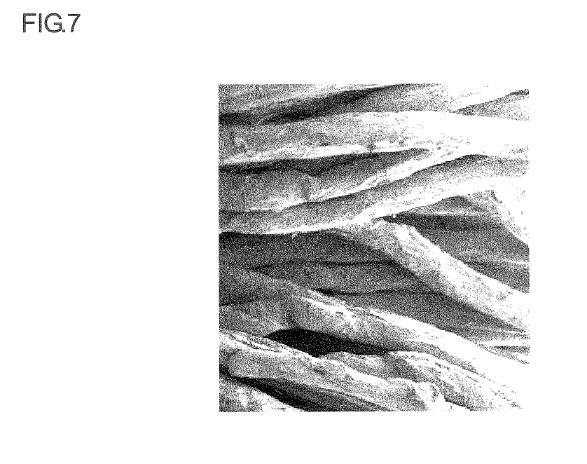

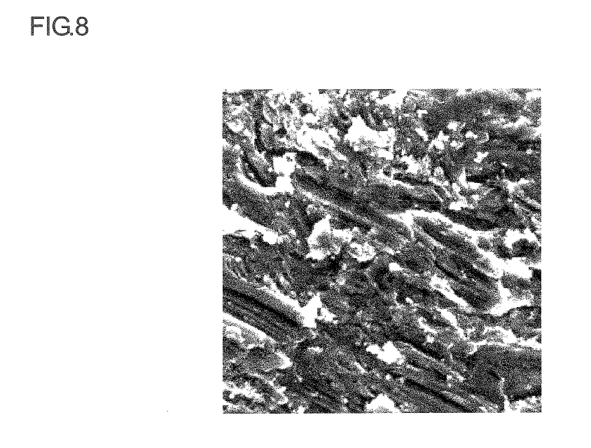

FIGS. 7 and 8 illustrate electron microscope photographs of the surfaces of the wires 15 after the application of ultrasonic vibration. The electron microscope photograph of FIG. 7 is taken at a magnification of 30 times and that of FIG. 8 is taken at a magnification of 4000 times.

### Example 2

Another electric wire with terminal connector 10 is manufactured in the same way as EXAMPLE 1 except for the condition that the contact pressure of the jigs 16 is 1 bar and the applied energy is 60 Ws.

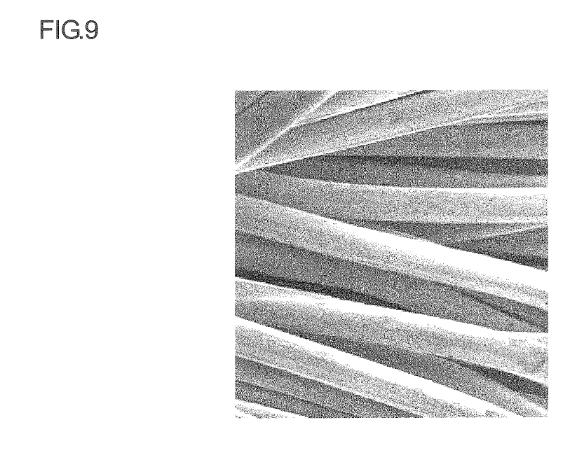

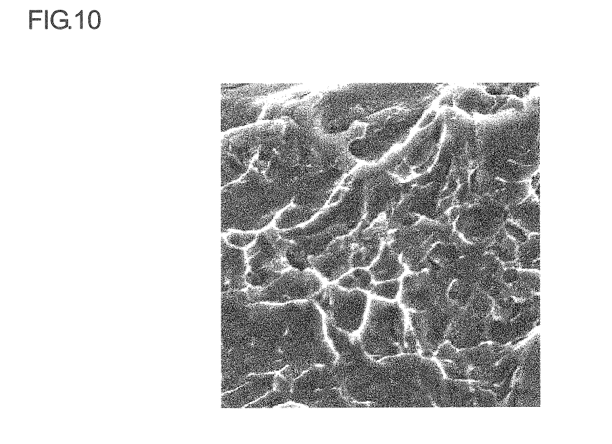

FIGS. 9 and 10 illustrate electron microscope photographs of the surfaces of the wires 15 after the application of ultrasonic vibration. The electron microscope photograph of FIG. 9 is taken at a magnification of 30 times and that of FIG. 10 is taken at a magnification of 4000 times.

### Example 3

Another electric wire with terminal connector 10 is manufactured in the same way as EXAMPLE 1 except for the condition that the contact pressure of the jigs 16 is 0.5 bar and the applied energy is 30 Ws.

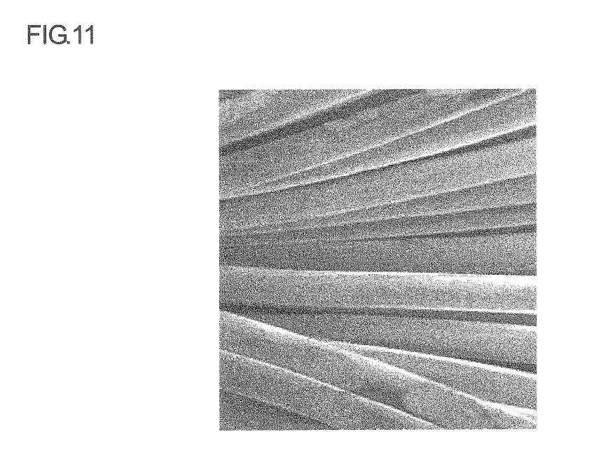

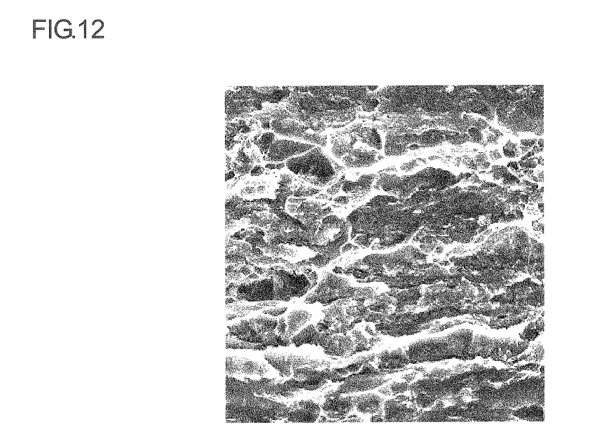

FIGS. 11 and 12 illustrate electron microscope photographs of the surfaces of the wires 15 after the application of ultrasonic vibration. The electron microscope photograph of FIG. 11 is taken at a magnification of 30 times and that of FIG. 12 is taken at a magnification of 4000 times.

### COMPARATIVE EXAMPLE 1

A metal plate material is pressed into a predetermined shape with a die. Then, the metal plate material that is formed in the predetermined shape is processed to be bent to form the connecting portion 20. Thereafter, the wire insulation 14 is removed from the electric wire 11 to expose the core wire 13 therefrom. Then, the wire barrel 19 is crimped onto the exposed core wire 13 and thus an electric wire with terminal connector 10 is manufactured.

As illustrated in FIG. 6, the wire 15 located close to a position P that is close to the radial outward portion of the core wire 13 and the wire 15 located close to a position Q that is close to the radial inward position of the core wire 13 are pulled out from the core wire 13 of the electric wire with terminal connector 10 thus manufactured to measure the electric resistance between the wires 15.

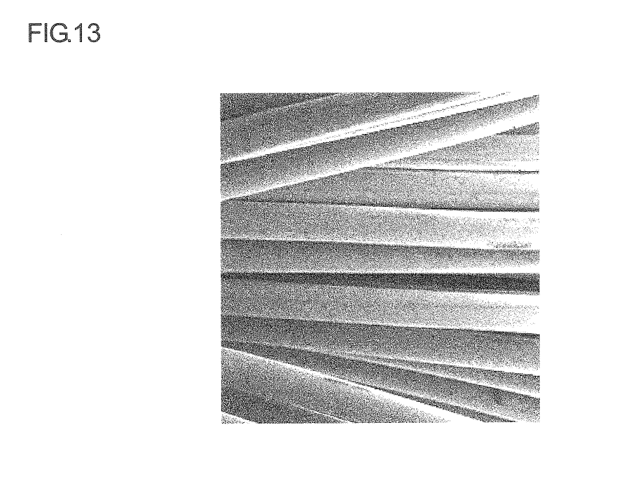

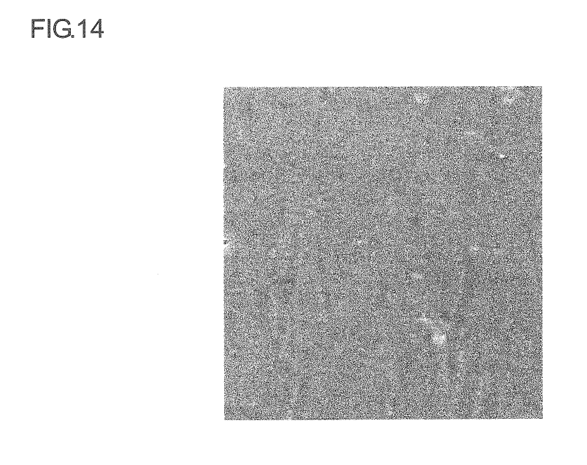

FIGS. 13 and 14 illustrate electron microscope photographs of the surfaces of the wires 15 after the application of ultrasonic vibration. The electron microscope photograph of FIG. 13 is taken at a magnification of 30 times and that of FIG. 14 is taken at a magnification of 4000 times.

<Results and Discussion>

(Roughed Portion 17)

As illustrated in FIG. 13, the surfaces of the wires 15 without the application of ultrasonic vibration according to COMPARATIVE EXAMPLE 1 are relatively smooth. If being observed with magnified as illustrated in FIG. 14, the surfaces of the wires 15 are still relatively smooth.

On the contrary, as illustrated in FIGS. 7 to 12, the roughed area 17 is formed on the surfaces of the wires 15 according to EXAMPLES 1 to 3 in which the ultrasonic vibration is applied to the core wire 13. Specifically, in EXAMPLE 1, the ultrasonic vibration is applied to the core wire 13 on the relatively strict condition that the contact pressure of the jigs 16 is 13 bar and the applied energy is 80 Ws. As illustrated in FIG. 7, irregularities are formed on the surface of each wire 15 and each wire 15 has an irregular shape in EXAMPLE 1. Further, as illustrated in FIG. 8, if the surfaces of the wires 15 are observed with magnified, they are not smooth and but rough (small irregularities are formed) and the roughed portion 17 is formed on the surfaces.

In EXAMPLE 2 in which the contact pressure of the jigs 16 is 1 bar and the applied energy is 60 Ws, as illustrated in FIG. 9, each wire 15 does not look like it has an irregular shape. However, as illustrated in FIG. 10, if the surfaces of the wires 15 are observed with magnified, they are not smooth but rough and the roughed portion 17 is formed on the surfaces of the wires 15.

In EXAMPLE 3, the ultrasonic vibration is applied to the core wire 13 on the relatively easy condition that the contact pressure of the jigs 16 is 0.5 bar and the applied energy is 30 Ws. As illustrated in FIG. 11, each wire 15 does not look like it has an irregular shape in EXAMPLE 3. However, as illustrated in FIG. 12, if the surfaces of the wires 15 are observed with magnified, they are not smooth but rough and the roughed portion 17 is formed.

(Electric Resistance)

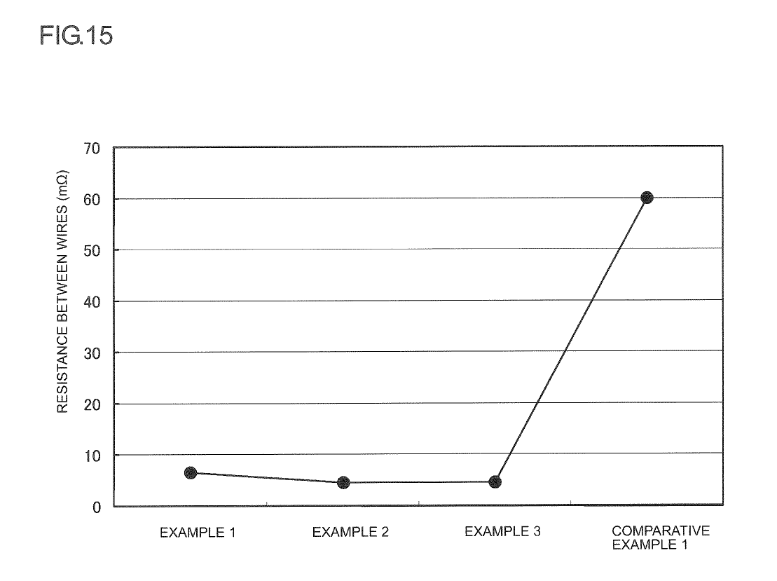

FIG. 15 illustrates a graph of electric resistances between the wires 15 measured in EXAMPLES 1 to 3 and COMPARATIVE EXAMPLE 1. As illustrated in FIG. 15, in EXAMPLES 1 to 3 in which the ultrasonic vibration is applied to the core wire 13, each of the electric resistances between the wires 15 is lower than 10 mg) that is a sufficiently low electric resistance value. On the contrary, in COMPARATIVE EXAMPLE 1 in which the ultrasonic vibration is not applied to the core wire 13, the electric resistance between the wires 15 is 60 mΩ that is a high value.

The above results are obtained because of the following reasons. The application of ultrasonic vibration to the core wire 13 causes the wires 15 of the core wire 13 to rub against each other. If the surfaces of the wires 15 rub against each other, the surfaces of the wires 15 are roughed to form the rouged portion 17 thereon.

If the wire barrel 19 is crimped onto the core wire 13 including wires 15 having the roughed portion 17 thereon, the wires 15 rub against each other by the application of force from the wire barrel 19. This causes the roughed portions 17 formed on the surfaces of the wire 15 to rub against each other and remove the wire insulation such as the oxide layer formed on the surfaces of the wires 15. Accordingly, surfaces of the wires 15 emerge and the exposed emerging surfaces are contacted to each other to achieve electric connection between the wires 15. Thus, the wires 15 located close to the radial inward portion of the core wire 13 contribute to the electric connection between the electric wire 11 and the terminal connector. This decreases the electric resistance between the electric wire 11 and the terminal connector.

(Experiments Relating to Posture of Core Wire 13 in Crimping Process)

The following shows results of experiments as to relation between a posture of the core wire 13 disposed on the wire barrel 19 and a holding direction of molds 50, 51 that hold the wire barrel 19 and the core wire 13.

### Example 4

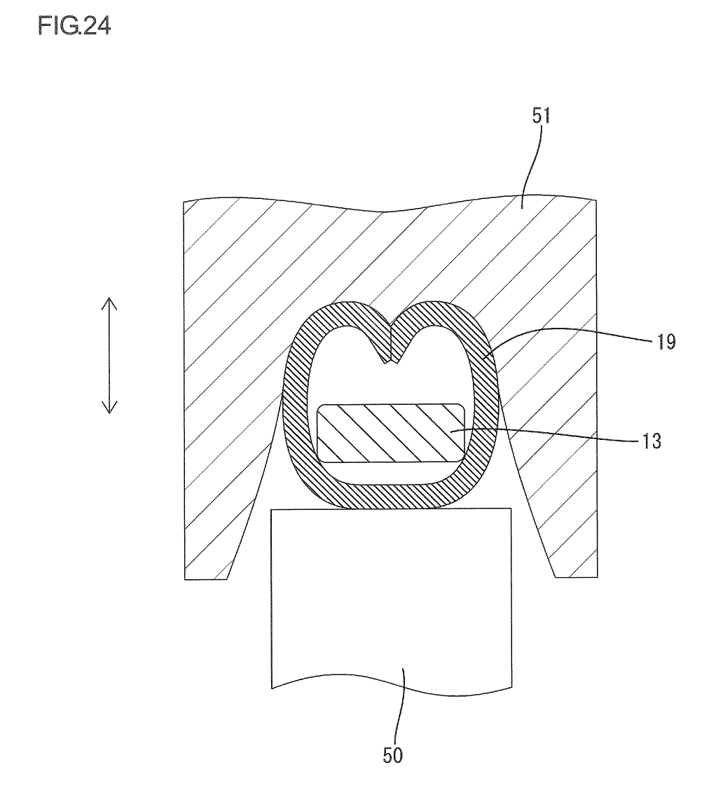

FIG. 24 illustrates one state of a crimping process in which the wire barrel 19 is crimped onto the core wire 13. As illustrated in FIG. 24, in EXAMPLE 4, the wire barrel 19 is disposed on an upper surface of the mold 50 that is located at a lower side in FIG. 24. The core wire 13 is disposed on an upper surface of the wire barrel 19. The core wire 13 is held between the jigs 16, 16 and the ultrasonic vibration is applied thereto. Accordingly, the wires 15 of the core wire 13 are welded to each other.

The core wire 13 has a flat rectangular cross-section. The flat surfaces of the core wire 13 are surfaces that are held by the jigs 16, 16. In EXAMPLE 4, the core wire 13 is disposed on the upper surface of the wire barrel 19 such that the flat surfaces of the core wire 13 face up and down respectively.

Thereafter, the mold 51 that is located at an upper side in FIG. 24 is moved downwardly toward the mold 50 that is located at the lower side. The lower surface of the mold 51 presses the wire barrel 19 downwardly. Further downward movement of the mold 51 causes the wire barrel 19 to be crimped onto an outer periphery of the core wire 13 so as to surround it. Accordingly, the electric wire with terminal connector 10 according to EXAMPLE 4 is manufactured. A compression rate of the core wire 13 is 60%.

The compression rate is defined by [(a cross-sectional area of a compressed core wire)/(a cross-sectional area of a pre-compressed core wire)]*100. Namely, the compression rate is defined by a percent of the cross-sectional area of the core wire after the crimping of the crimping portion with respect to the cross-sectional area of the core wire before the crimping of the crimping portion.

According to the above definition of the electric wire compression rate, reducing the electric wire compression rate means compressing the core wire with high pressure (high compression) and increasing the electric wire compression rate means compressing the core wire with low pressure (low compression).

### Example 5

An electric wire with terminal connector 10 is manufactured in the same way as EXAMPLE 4 other than the condition that the electric wire compression rate is 70%.

### Example 6

An electric wire with terminal connector 10 is manufactured in the same way as EXAMPLE 4 other than the condition that the electric wire compression rate is 80%.

(Measuring Fixing Strength)

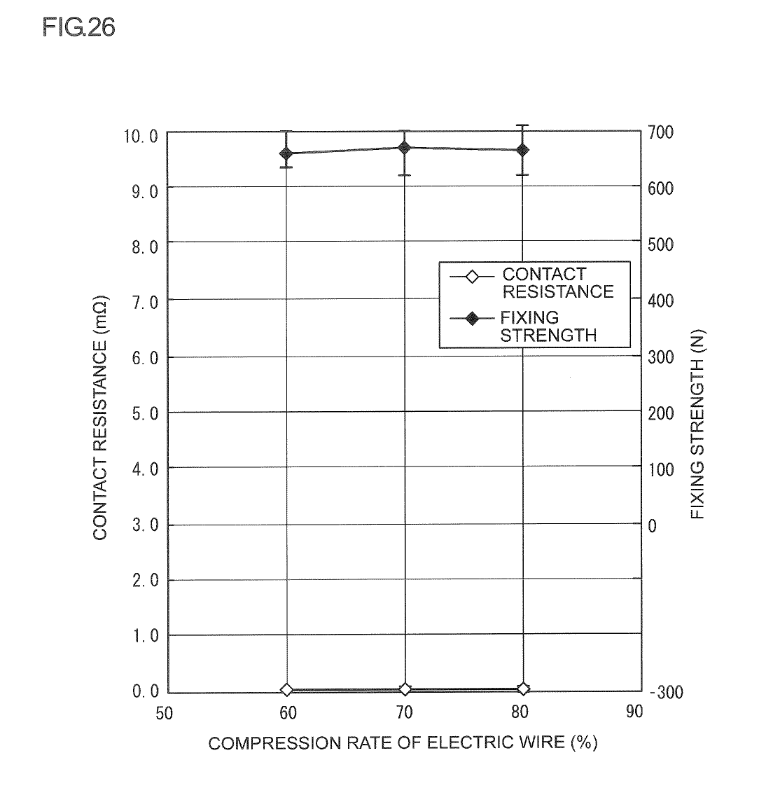

Fixing strength between the electric wire 11 and the wire barrel 19 is measured for each electric wire with terminal connector 10 manufactured according to EXAMPLES 4 to 6. Each of the electric wire 11 and the female terminal connector 12 including the wire barrel 19 is held by a jig respectively and tension testing is carried out at 100 mm/second. Stress at the separation of the electric wire 11 from the wire barrel 19 is referred to as fixing strength. Fixing strength is measured for 20 samples and average values are illustrated in FIG. 26. A maximum value and a minimum value of the samples are represented by error bars in FIG. 26.

(Measuring Electric Resistance)

An electric resistance value between the core wire 13 and the wire barrel 19 is measured for each electric wire with terminal connector 10 according to EXAMPLES 4 to 6. An average value is obtained and the results are illustrated in FIG. 26.

### Example 7

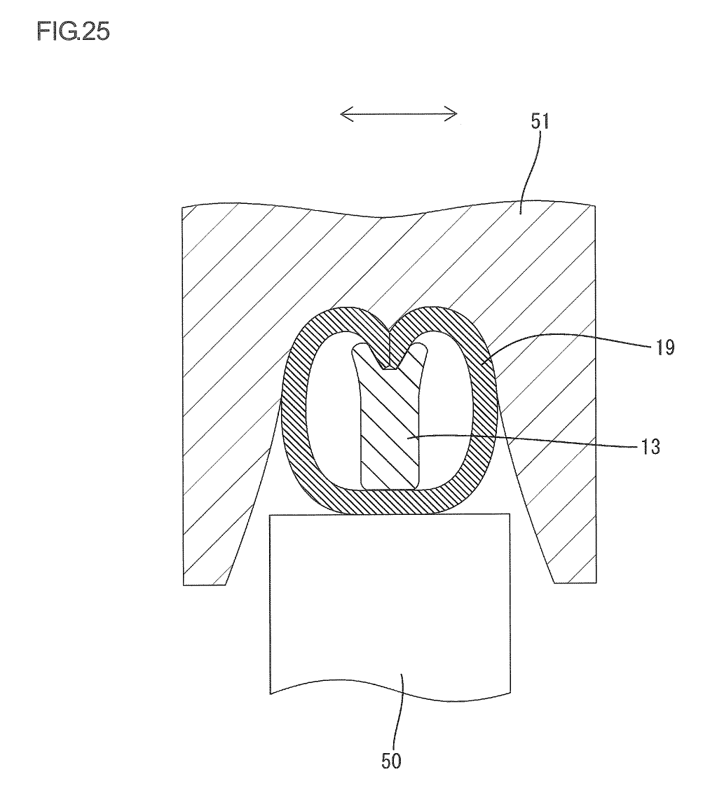

As illustrated in FIG. 25, in EXAMPLE 7, the core wire 13 is disposed on the upper surface of the wire barrel 19 such that the flat surfaces of the core wire 13 lie along a horizontal line.

Then, the mold 51 that is located at an upper side in FIG. 25 is moved downwardly toward the mold 50 that is positioned at a lower side and thus the electric wire with terminal connector is manufactured according to EXAMPLE 7. The electric wire compression rate is 60%.

### Example 8

An electric wire with terminal connector 10 is manufactured in the same way as EXAMPLE 7 other than the condition that the electric wire compression rate is 70%.

### Example 9

An electric wire with terminal connector 10 is manufactured in the same way as EXAMPLE 7 other than the condition that the electric wire compression rate is 80%.

(Measuring Fixing Strength)

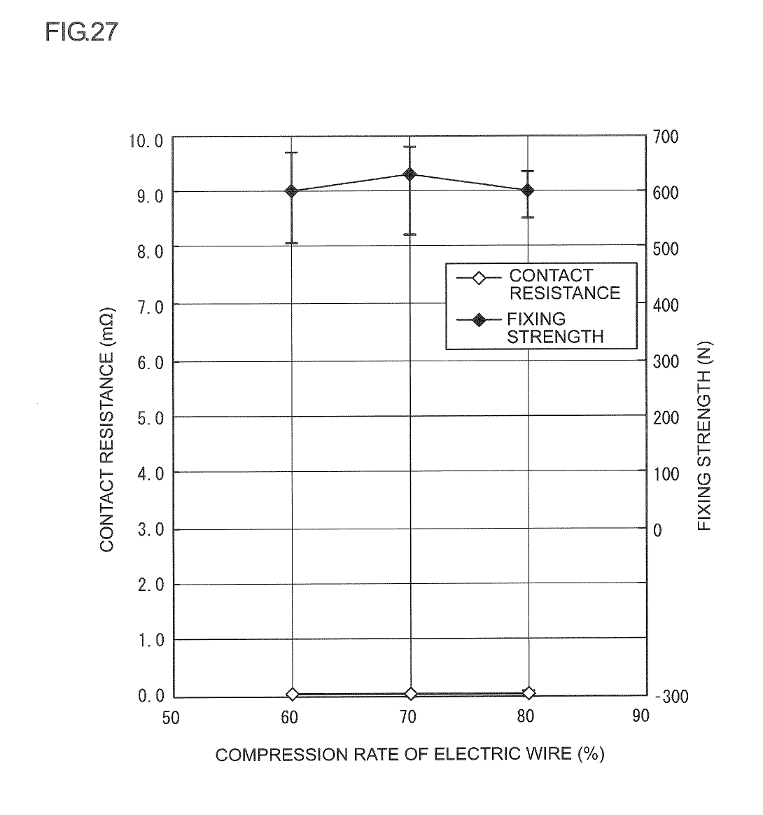

Fixing strength is measured in the same way as described above for the electric wires 10 with terminal connectors according to EXAMPLES 7 to 9. The results are illustrated in FIG. 27.

(Measuring Electric Resistance Value)

Electric resistance values are measured in the same way as described above for the electric wires 10 with terminal connectors according to EXAMPLES 7 to 9. The results are illustrated in FIG. 27.

(Results and Discussion)

As illustrated in FIG. 26, in each electric wire with terminal connector 10 according to EXAMPLES 4 to 6, the electric resistance values between the core wire 13 and the wire barrel 19 are lower than 1.0 mΩ. As illustrated in FIG. 27, also in each electric wire with terminal connector 10 according to EXAMPLES 7 to 9, the electric resistance values between the core wire 13 and the wire barrel 19 are loser than 1.0 mΩ. Thus, it is confirmed that the application of ultrasonic vibration to the core wire 13 decreases the electric resistance value between the core wire 13 and the wire barrel 19.

As illustrated in FIG. 26, each electric wire with terminal connector according to EXAMPLES 4 to 6 has the fixing strength of 650 N or greater. Variation (difference between the maximum value and the minimum value) in the samples of each EXAMPLE is 100 N or smaller.

On the contrary, as illustrated in FIG. 27, each electric wire with terminal connector according to EXAMPLES 7 to 9 has the fixing strength of 630 N or smaller. The variation in the samples of each EXAMPLE is greater compared to that in EXAMPLES 4 to 6. For example, the variation in the samples of EXAMPLE 7 is approximately 170 N and the variation in the samples of EXAMPLE 8 is approximately 160 N. The fixing strength of each electric wire with terminal connector according to EXAMPLES 7 to 9 is sufficiently great and the variation in the samples of EXAMPLES 7 to 9 is sufficiently small. However, each electric wire with terminal connector 10 according to EXAMPLES 4 to 6 has excellent quality.

If the wires 15 are welded by the application of ultrasonic vibration to the core wire 13, the adjacent wires 15 are welded in the holding direction of the jigs 16, 16 provided in a pair. In FIGS. 24 and 25, the adjacent wires 15 are welded in the direction represented by arrows in the drawing.

As illustrated in FIG. 24, in each electric wire with terminal connector 10 according to EXAMPLES 4 to 6, the direction in which the molds 50, 51 hold the core wire 13 and the wire barrel (the vertical direction in FIG. 24) is aligned with the direction in which the adjacent wires 15 are welded. Therefore, it is suppressed that the force is applied to the welded wires 15 so as to be separated from each other when the wire barrel 19 is crimped onto the core wire 13. This suppresses the wires 15 from being damaged when the wire barrel 19 is crimped onto the core wire 13. Therefore, this improves the fixing strength between the core wire 13 and the wire barrel 19.

On the contrary, as illustrated in FIG. 25, in each electric wire with terminal connector 10 according to EXAMPLES 7 to 9, when the wire barrel 19 is crimped onto the core wire 13, the force is applied to the core wire 13 in the direction (a vertical direction in FIG. 25) crossing to the direction in which the jigs 16, 16 hold the core wire 13 (in the direction represented by an arrow in FIG. 25). Therefore, the force is applied to the welded wires 15 so as to be separated from each other. If the welded wires 15 are separated from each other, the surfaces of the wires 15 may be damaged. This lowers the strength of the wires 15 forming the core wire 13 and this makes the fixing strength between the core wire 13 and the wire barrel 19 to be lowered compared to that in EXAMPLES 4 to 6. The variation in the samples is greater compared to that in EXAMPLES 4 to 6.

### Second Embodiment

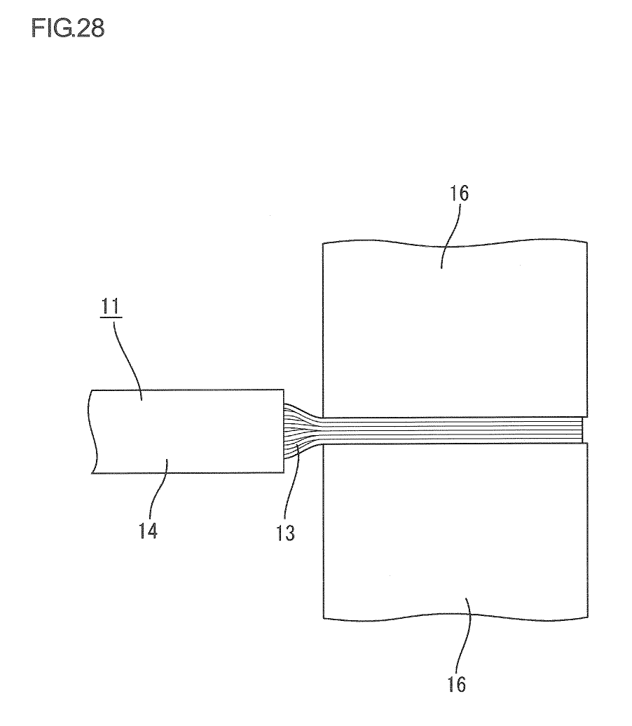

Next, a second embodiment of the present invention will be explained with reference to FIGS. 28 to 30. As illustrated in FIG. 28, according to the present embodiment, the core wire 13 exposed at the end of the electric wire 11 is held between the jigs 16, 16 provided in a pair. At this time, the core wire 13 is disposed over a substantially entire disposing surface of the jig 16 in a longitudinal direction of the core wire 13.

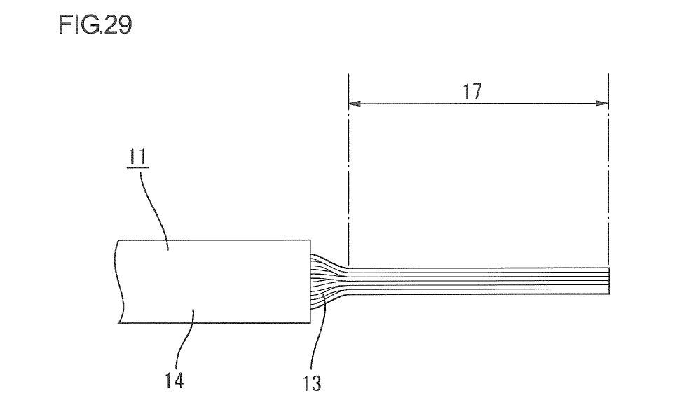

Accordingly, the ultrasonic vibration is applied substantially evenly to the entire portion of the core 13 that is held between the jigs 16. As a result, as illustrated in FIG. 29, the surfaces of the wires 15 are roughed substantially evenly in the roughed portion 17 of the core wire 13.

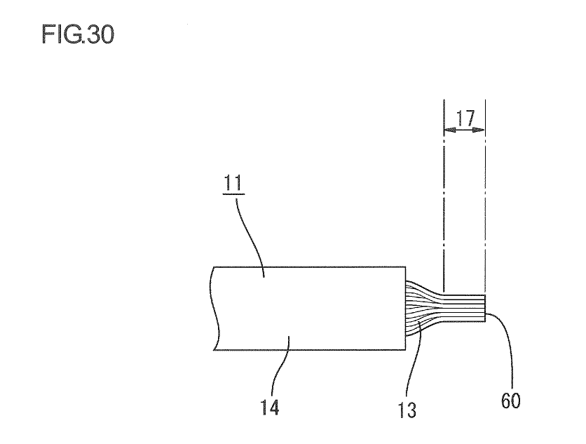

Then, as illustrated in FIG. 30, the core wire 13 is cut in the roughed portion 17 to have a predetermined length by a known method such as a cutter. Accordingly, a cut surface 60 is formed at an end of the core wire 13 after cutting.

Thereafter, the wire barrel 19 of the female terminal connector 12 is crimped onto the core wire 13 having the cutting surface 60 in the same way as the first embodiment. Accordingly, the electric wire with terminal connector 10 is manufactured.

Other structural features are mostly the same as those of the first embodiment. The same parts are indicated by the same symbols and will not be explained.

The application of ultrasonic vibration to the core wire 13 extends the wires 15 of the core wire 13. At this time, the wires 15 are not necessarily extended equally. Therefore, if the core wire 13 is exposed at the end of the electric wire 11 and the ultrasonic vibration is applied to the exposed core 13, the distal ends of the wires 15 may not align on the same plane at the end of the core wire 13. If the wire barrel 19 is crimped onto the core wire 13 in such a state, the size accuracy of the arrangement of the core wire 13 and the wire barrel 19 is lowered and this may cause a position gap between the electric wire 11 and the female terminal connector 12.

According to the present embodiment, the core wire 13 is cut in the roughed portion 17 to which the ultrasonic vibration is applied. This makes the ends of the wires 15 to lie in the same plane at the cut surface of the core wire 13. As a result, the position gap between the electric wire 11 and the female terminal connector 12 is suppressed to be caused.

According to the present embodiment, the core wire 13 is disposed on a substantially entire surface of the jig 16 that applies the ultrasonic vibration to the core wire 13. Therefore, the ultrasonic vibration is applied substantially evenly to the core wire 13. This makes the surfaces of the wires 15 to be evenly roughed in the roughed portion 17. As a result, when the wire barrel 19 is crimped onto the core wire 13, the wires 15 rub against each other and the surface of the wire 15 evenly emerges. This improves reliability of the electric connection between the wires 15.

### Other Embodiments

The present invention is not limited to the aspects explained in the above description made with reference to the drawings. The following aspects may be included in the technical scope of the present invention, for example.

(1) In the above embodiments, the roughed portion 17 has a larger area than the crimped portion 24. However, the roughed portion 17 may have the same area as the crimped portion 24, or the roughed portion 17 may be framed in a part of the crimped portion 24.

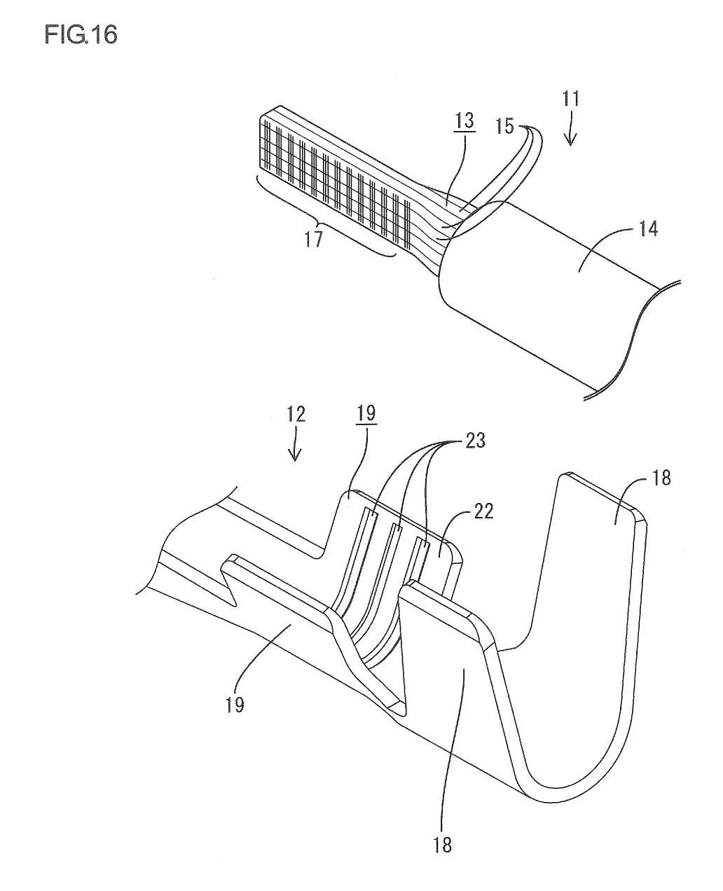

(2) An angle made by the direction in which the jigs 16, 16 hold the core wire 13 therebetween and the direction in which the metal molds hold the wire barrel 19 may be arbitrarily defined. For example, as illustrated in FIG. 16, the wire barrel 19 may be crimped onto the core wire 13 such that the direction in which the jigs 16, 16 hold the core wire 13 crosses to the direction in which the metal molds hold the wire barrel 19.

(3) As long as the roughed portion 17 is formed on the surfaces of the wires 15 by the application of ultrasonic vibration, the wires 15 may not be welded to each other. After the welded wires 15 are separated from each other, they may be crimped onto the wire barrel 19.

(4) The wire barrel 19 may be crimped onto the core wire 13 such that the wire barrel portions are offset from each other in an extending direction of the electric wire 11. The wire barrel 19 may include three or more wire barrel portions so as to be offset from each other on right and left sides. The wire barrel 19 may include only one wire barrel portion that is crimped onto the core wire 13. The wire barrel 19 may have any shape suitable for intended application.

(5) In the above embodiments, the female terminal connector 12 including the connecting portion 20 is used as a terminal connector. However, a male terminal connector including a male tab or an LA terminal that is formed of a metal plate having a penetrating opening therein may be used. The terminal connector can have any shape suitable for intended application.

(6) In the above embodiments, the electric wire 11 is a covered wire that is formed by covering the outer periphery of the core wire 13 with the wire insulation 14. However, it may be a shielded wire 11. Any kind of wire suitable for intended application can be used.

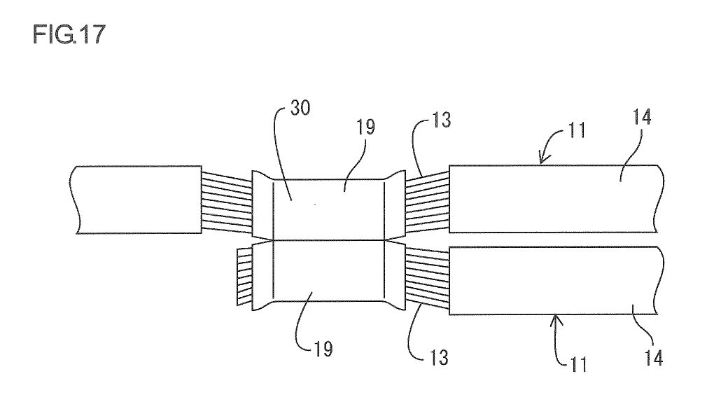

(7) In the above embodiments, the terminal connector includes the wire barrel 19 and the connecting portion 20 that are adjacent to each other. However, the terminal connector without the connecting portion 20 can be used. For example, the terminal connector may have an intermediate splicing structure in which the core wires 13 of two different wires 11 are connected as illustrated in FIG. 17. A part of the wire insulation 14 located at the end of one of the electric wires 11 is removed so that the core wire 13 therein emerges. A part of the wire insulation 14 located at the middle portion of the other one of the electric wires 11 is removed so that the core wire 13 therein emerges. Then, the wire barrels 19 provided in a pair are crimped onto the respective core wires 13. Another intermediate splicing structure can be applied. Both core wires 13 of two different electric wires 11 may be exposed at the middle portions of the electric wires 11, respectively. Then, the wire barrel portions provided in a pair are crimped onto the bare portions of the respective core wires 13.

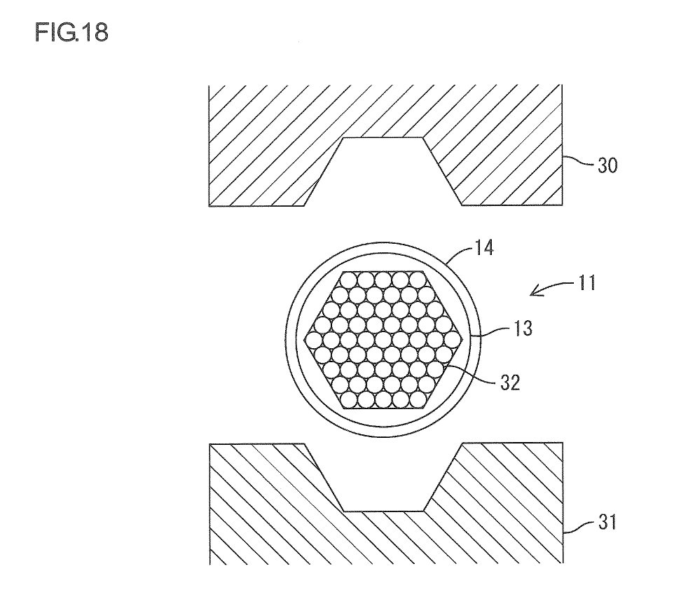

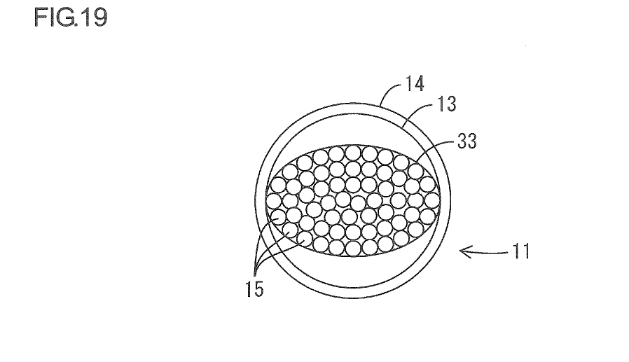

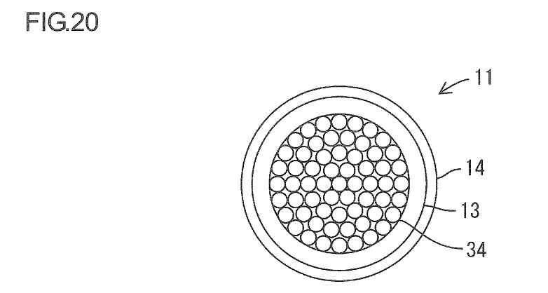

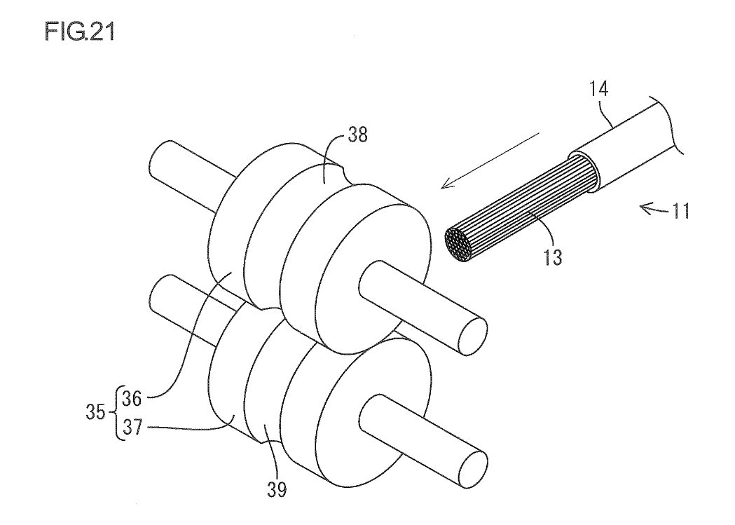

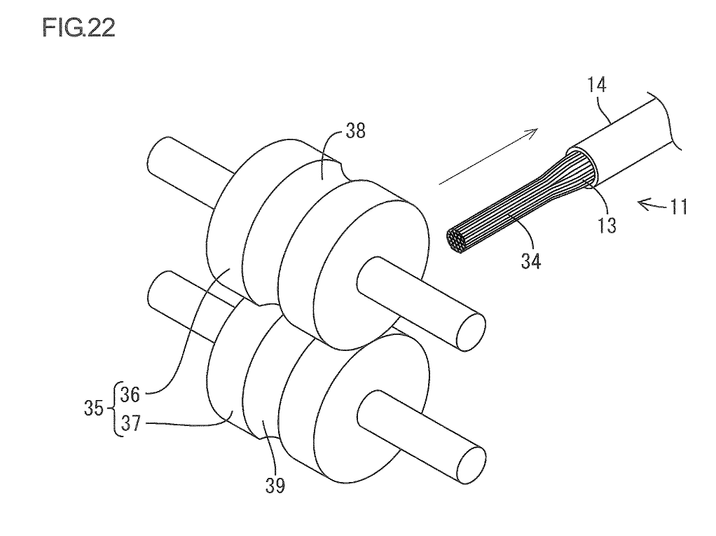

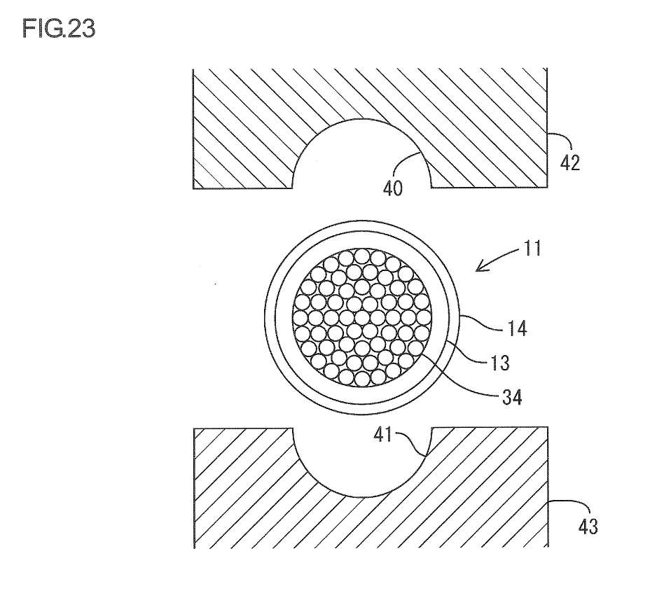

(8) In the above embodiments, the core wire 13 is plastically deformed into a flat square column (rectangular shape) by the jigs 16 and the ultrasonic vibration is applied to the plastically-deformed portion. However, the core wire 13 may be plastically deformed into a square shape other than the flat square column and the ultrasonic vibration may be applied to the plastically-deformed portion. Moreover, the core wire 13 may be plastically deformed into any polygonal shape other than the square shape and the ultrasonic vibration may be applied to the plastically-deformed portion. For example, as illustrated in FIG. 18, the circular core wire 13 may be plastically deformed into a hexagonal shape by jigs 30, 31 including an upper metal mold and a lower metal mold to form a plastically-deformed portion 32. The ultrasonic vibration may be applied to the plastically-deformed portion 32 via the jigs 30, 31. The plastically-deformed portion having a shape other than a polygonal shape may be formed. For example, as illustrated in FIG. 19, a plastically-deformed portion 33 may be formed by plastically deforming the core wire 13 into an ellipsoidal shape by the jigs (metal molds) and the ultrasonic vibration may be applied to the plastically-deformed portion 33. Further, as illustrated in FIG. 20, a diameter of the core wire 13 may be reduced by jigs to form a plastically-deformed portion 34 having a circular diameter-reduced portion. Then, the ultrasonic vibration may be applied to the plastically-deformed portion 34. The plastically-deformed portion (diameter-reduced portion) 34 may be formed by the jigs (metal molds) or a roller pressing process. Specifically, as illustrated in FIG. 21, a groove 28, 29 is formed in a respective outer peripheral surface of rollers 36, 37 of a roller device 35 so as to have a semicircular shape (a circular arc). As illustrated in FIG. 22, the core wire 13 is pressed by the semicircular-shaped surfaces of the grooves 38, 39 of the rollers 36, 37, and the plastically-deformed portion 34 (diameter-reduced portion) may be thus formed. After the formation of the plastically-deformed portion 34 (diameter-reduced portion), the ultrasonic vibration may be applied to the core wire 13 via jigs 42, 43 (that do not plastically deform the core wire) having grooves 40, 41, as illustrated in FIG. 23. Each of the grooves 40, (recesses) has a semicircular shape having a diameter same as the plastically-deformed portion 34 (diameter-reduced portion).

1. A method of manufacturing an electric wire with terminal connector including an electric wire and a terminal connector, the electric wire being comprised of a core wire including a plurality of wires, and the terminal connector including a crimping portion that is crimped onto the core wire exposed from the electric wire, the method comprising:
a step of removing wire insulation covering an outer peripheral surface of the core wire to expose the core wire;
a step of holding the exposed core wire with jigs provided in a pair and applying ultrasonic vibration to the core wire via the jigs; and
a step of crimping the crimping portion onto a part of the core wire to which ultrasonic vibration is applied, the crimping portion being crimped onto the part so as to surround the part.

2. The method of manufacturing an electric wire with terminal connector according to claim 1, wherein the wires are welded to each other by the application of ultrasonic vibration.

3. The method of manufacturing an electric wire with terminal connector according to claim 1, wherein:
in the step of crimping the crimping portion onto the core wire, the core wire is disposed on the crimping portion and molds provided in a pair hold the core wire and the crimping portion therebetwen to press the crimping portion, and the core wire is disposed on the crimping portion so that a direction toward which a surface of the core wire held by the jigs faces is aligned with a direction in which the molds hold the core wire and the crimping portion.

4. The method of manufacturing an electric wire with terminal connector according to claim 1, wherein the core wire has a crimped portion onto which the crimping portion is crimped, and an area of the core wire to which the ultrasonic vibration is applied is equal to or larger than an area of the crimped portion.

5. The method of manufacturing an electric wire with terminal connector according to claim 1, further comprising a step of cutting the core wire in the part to which the ultrasonic vibration is applied.

6. The method of manufacturing an electric wire with terminal connector according to claim 1, wherein the wire is made of any one of aluminum and aluminum alloy.

7. An electric wire with terminal connector comprising:
an electric wire being comprised of a core wire including a plurality of wires;
a terminal connector being crimped onto the core wire exposed from the electric wire, the electric wire with terminal connector; and
a roughed portion formed on a surface of the wire of the core wire that is exposed from the electric wire, the roughed portion being formed by application of ultrasonic vibration to the wire, wherein the terminal connector includes a crimping portion that is crimped onto an outer surface of the core wire so as to surround the core wire, and the crimping portion is crimped onto the roughed portion.

8. The electric wire with terminal connector according to claim 7, wherein the wires are welded to each other by the application of ultrasonic vibration.

9. The electric wire with terminal connector according to claim 7, wherein the roughed portion has an area equal to or greater than the crimped portion onto which the crimping portion is crimped.

10. The electric wire with terminal connector according to claim 7, wherein the core wire includes a cut surface that is formed by cutting the core wire in the roughed portion.

11. The electric wire with terminal connector according to claim 7, wherein the wire is made of any one of aluminum and aluminum alloy.
